(19) United States
(12) Patent Application Publication
(10) Pub. No.: US 2011/0066451 A1
(43) Pub. Date: Mar. 17, 2011

(54) METHOD AND APPARATUS FOR PROVIDING HEALTH MANAGEMENT INFORMATION

(75) Inventors: Woo-young Jang, Seongnam-si (KR); Kyu-tae Yoo, Seongnam-si (KR)

(73) Assignee: SAMSUNG ELECTRONICS CO., LTD., Suwon-si (KR)

(21) Appl. No.: 12/780,262

(22) Filed: May 14, 2010

(30) Foreign Application Priority Data
Sep. 15, 2009 (KR) 10-2009-0087080

(51) Int. Cl. G06Q 50/00; G06Q 10/00; G06F 17/30

(52) U.S. Cl. 705/3; 707/737; 707/748; 707/E17.046

(57) ABSTRACT

A method and apparatus for providing health management information to a patient. Patients are grouped according to their personal health records, order is determined between the patients in each group, and health management information of a patient highly ordered in each group is automatically provided to a patient lower ordered in the each group.

### CROSS-REFERENCE TO RELATED APPLICATIONS

This application claims priority to Korean Patent Application No. 10-2009-0087080, filed on Sep. 15, 2009, and all the benefits accruing therefrom under 35 U.S.C. §119, the disclosure of which is incorporated herein in its entirety by reference.

### BACKGROUND

1. Field

The present disclosure relates to methods and apparatuses for providing health management information to a patient.

2. Description of the Related Art

In order to reduce increasing medical expenses in the United States of America (“USA”), home health care services for reducing the number of hospital visits and the number of days for hospitalization are increasing. As such, a service for reducing medical expenses by having a medical professional, such as a doctor, remotely managing a disorder of a patient at home is called a home tele-monitoring service. A home tele-monitoring device is a device provided to the patient so that the patient staying at home may be monitored by a medical professional via the home tele-monitoring service.

### SUMMARY

Provided are methods and apparatuses for providing health management information to a patient in order to motivate the patient to take care of his/her health.

Provided are computer readable recording medium recorded thereon a program for executing the methods.

Additional aspects will be set forth in part in the description which follows and, in part, will be apparent from the description, or may be learned by practice of the illustrated embodiments.

Provided is a method of providing health management information, the method including classifying patients into one or more groups based on similarity between personal heath records of the patients; determining an order between patients in a group, based on corresponding health conditions of the patients, for each group; and providing health management information of at least one patient whose determined order is equal to or above a predetermined order to at least one patient whose determined order is below the predetermined order.

Provided is a computer readable recording medium having recorded thereon a program for executing the method.

Provided is an apparatus for providing health management information, the apparatus including a grouping unit for classifying patients into one or more groups based on similarity between personal heath records of the patients, an order determining unit for determining an order of each patient with respect to groups to which the patients belong, based on corresponding health conditions of the patients, a report generating unit for generating a report based on health management information of at least one patient whose determined order is equal to or above a predetermined order, and a communicating unit for transmitting the generated report to at least one patient whose determined order is below the predetermined order.

### BRIEF DESCRIPTION OF THE DRAWINGS

These and/or other aspects will become apparent and more readily appreciated from the following description of the embodiments, taken in conjunction with the accompanying drawings of which:

FIG. 1 is a diagram of an exemplary embodiment of a health management system, according to the present invention;

FIG. 2 is a diagram illustrating an exemplary embodiment of contents stored in databases of an apparatus for providing health management information illustrated in FIG. 1;

FIG. 3 is a flowchart of an exemplary embodiment of a method of providing health management information, according to the present invention; and

FIG. 4 is a diagram for describing an exemplary embodiment of how health management information is provided according to the health management system of FIG. 1 or the method of FIG. 3.

### DETAILED DESCRIPTION

Reference will now be made in detail to exemplary embodiments, which are illustrated in the accompanying drawings, wherein like reference numerals refer to the like elements throughout. In this regard, the exemplary embodiments may have different forms and should not be construed as being limited to the descriptions set forth herein. Accordingly, the embodiments are merely described below, by referring to the figures, to explain aspects of the invention.

It will be understood that when an element or layer is referred to as being “connected to” another element or layer, the element or layer can be directly connected to another element or layer or intervening elements or layers. In contrast, when an element is referred to as being “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

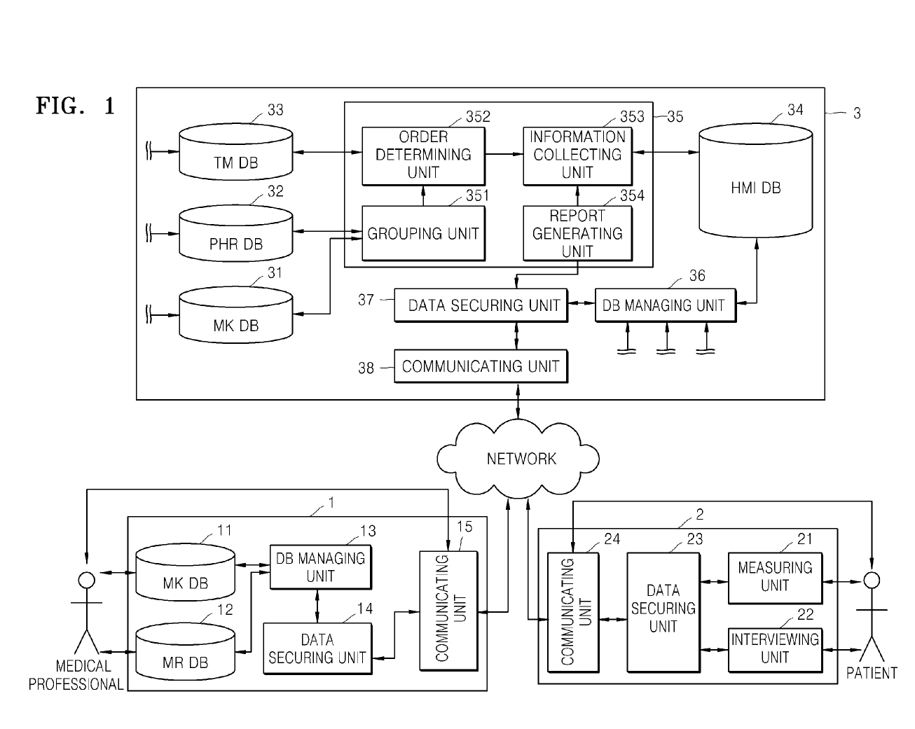

FIG. 1 is a diagram of an exemplary embodiment of a health management system, according to the present invention. Referring to FIG. 1, the health management system according to the illustrated embodiment of the present invention includes a health management server 1, a patient terminal 2, and an apparatus 3 for providing health management information. FIG. 1 briefly illustrates that only one patient terminal 2 is connected to the apparatus 3, but a plurality of the patient terminal, like the patient terminal 2, may be connected to the apparatus 3.

The health management server 1, the patient terminal 2, and the apparatus 3 each communicate with each other through a network, and accordingly, respectively include communicating units 15, 24, and 38 for supporting network communication between the health management server 1, the patient terminal 2, and the apparatus 3. The network is generally a global network (e.g., the Internet), but one of ordinary skill in the art would understand that the network may vary, for example, the network may be a wireless local area network (“LAN”), a wide area network (“WAN”), a virtual private network (VPN), and an intranet. The network may be implemented using a wireless network or any kind of physical network implementation known in the art. The health management server 1, the patient terminal 2, and the apparatus 3 may be coupled to each other through multiple networks (e.g., intranet and Internet) so that the health management server 1, the patient terminal 2, and the apparatus 3 are not coupled to one another through the same network.

Also, hereinafter, the health management server 1, the patient terminal 2, and the apparatus 3 are described as separate devices, but one of ordinary skill in the art would understand that the health management server 1, the patient terminal 2, and the apparatus 3 may be integrated as one or two devices. In one exemplary embodiment, all or some functions of the health management server 1 may be installed in the apparatus 3, or all or some functions of the apparatus 3 may be installed in the patient terminal 2.

Referring to FIG. 1, the health management server 1 includes a medical knowledge (“MK”) database 11, a medical record (“MR”) database 12, a database managing unit 13, a data securing unit 14, and the communicating unit 15. The MK database 11 stores medical knowledge, such as patient classification knowledge indicating patient classifying items for medically classifying patients, and patient similarity knowledge indicating an order of the patient classification items regarding the degree of contribution to medical similarity of patients.

The patient classification knowledge may include, but is not limited to, patient classification items such as information regarding a disorder, a physical character, a family history, a life style, medical data, and a demographical character. The patient similarity knowledge may include, but is not limited to, systematized knowledge that a disorder, medical data, a family history, a physical character, a life style, and a demographical character highly contribute to medical similarity of patients in the order stated. The MR database 12 stores personal medical records of patients. In one exemplary embodiment, the MR database 12 stores a diabetes treatment history of a patient.

The database managing unit 13 of the health management server 1 manages the MK database 11 and the MR database 12. In one exemplary embodiment, the database managing unit 13 updates the MK database 11 and/or the MR database 12, and/or extracts medical knowledge or a medical record respectively from the MK database 11 and the MR database 12 to be applied to databases of the apparatus 3. The updating of the MK database 11 and the MR database 12 may generally performed as a medical professional (FIG. 1) operating the health management server 1 respectively inputs new medical knowledge and a new medical record, but the invention is not limited thereto. According to the illustrated embodiment of the present invention, the medical professional is generally a doctor.

The data securing unit 14 of the health management server 1 performs a security process on data output from or input to the communicating unit 15. In one exemplary embodiment, the data securing unit 14 may encode data output to the communicating unit 15, e.g., medical knowledge or a medical record extracted by the database managing unit 13, or may convert identification information, such as a real name of a patient (FIG. 1), into a code, such as a number or a character, that cannot be broken by an unrelated person. Alternatively, the data securing unit 14 may decode data input from the communicating unit 15, e.g., encoded health management information fed back from the apparatus 3 to the communicating unit 15. In an exemplary embodiment, the health management server 1 may further include a unit (not shown) for displaying the decoded health management information from the data securing unit 14. In an alternative exemplary embodiment, when personal medical information of a patient is prevented from being exposed, such as when the health management system of FIG. 1 is installed in a closed environment, the health management server 1 may not include the data securing unit 14.

The communicating unit 15 of the health management server 1 outputs data received from the apparatus 3 through the network, to the data securing unit 14, or transmits data security-processed by the data securing unit 14 to the apparatus 3 through the network. In detail, the communicating unit 15 may transmit the security-processed data to the apparatus 3 periodically, when at least one of the medical knowledge stored in the MK database 11 and the medical record stored in the MR database 12 is changed, or according to a direction of the medical professional operating the health management server 1.

Referring to FIG. 1, the patient terminal 2 includes a measuring unit 21, an interviewing unit 22, a data securing unit 23, and the communicating unit 24. The measuring unit 21 measures a medical signal, such as a blood-sugar level, of a patient using the patient terminal 2. The measuring unit 21 for measuring a medical signal of the patient may be included in the patient terminal 2, attached to the patient terminal as a separate device, and/or remotely connected to the patient terminal 2. One of ordinary skill in the art would understand that the configuration of the measuring unit 21 is not limited thereto, and may vary. In detail, the measuring unit 21 may measure a medical signal of the patient by using the patient terminal 2 periodically, according to a direction of the medical professional operating the apparatus 3 received from the communicating unit 24, or according to a direction of the patient.

The interviewing unit 22 of the patient terminal 2 displays a question related to a health condition of the patient using the patient terminal 2. The question, for example, may be in regards to a personal health record of the patient, such as information regarding a medical history, a physical character, a family history, a life style, medical data, or a demographical character of the patient, or may be in regards to health management information, such as information regarding a meal menu, an amount of meal eaten by the patient, or types of or duration of exercises performed by the patient. Then, the interviewing unit 22 receives a response regarding the question from the patient. In detail, the interviewing unit 22 may display the question periodically, according to a direction of the medical professional, the direction received through the communicating unit 24, or according to a direction of the patient. Also, the interviewing unit 22 may display a best practice (“BP”) report provided from the apparatus 3 to the patient. Here, the BP report may be displayed on a display panel (not shown) prepared separately from the interviewing unit 22.

The data securing unit 23 of the patient terminal 2 performs a security process on data output from or input to the communicating unit 24. In one exemplary embodiment, the data securing unit 23 may encode data output to the communicating unit 24, e.g., information about a medical signal measured by the measuring unit 21 or interview details input to the interviewing unit 22, or may convert identification information, such as a real name of the patient, into a code, such as a number or a character, that cannot be broken by an unrelated person. Alternatively, the data securing unit 23 may decode data input from the communicating unit 24, e.g., encoded health management information fed back from the apparatus 3 to the communicating unit 24. In an alternative exemplary embodiment, when personal medical information of a patient is prevented from being exposed, such as when the health management system of FIG. 1 is installed in a closed environment, the patient terminal 2 may not include the data securing unit 23.

The communicating unit 24 of the patient terminal 2 outputs data received from the apparatus 3 through the network, to the data securing unit 23, or transmits data that is security-processed by the data securing unit 23 to the apparatus 3 through the network. In detail, the communicating unit 24 may transmit the security-processed data periodically, when a new medical signal is measured by the measuring unit 21, when new interview details are generated by the interviewing unit 22, or according to a direction of the patient.

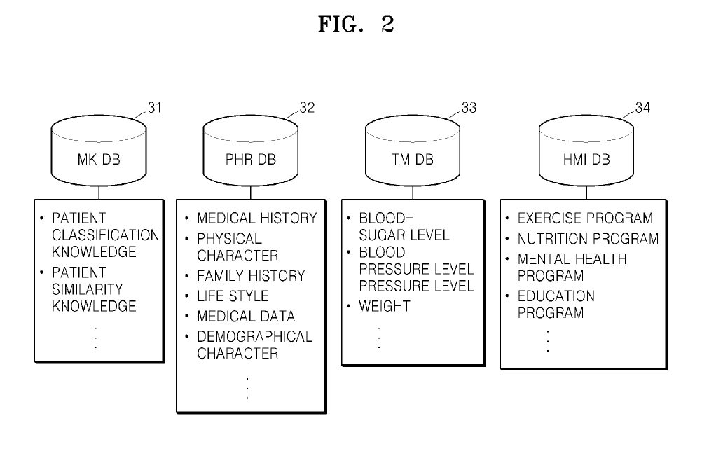

Referring to FIG. 1, the apparatus 3 includes an MK database 31, a personal health record (“PHR”) database 32, a telemonitoring (“TM)” database 33, a health management information (“HMI”) database 34, a data processing unit 35, a database managing unit 36, a data securing unit 37, and the communicating unit 38. FIG. 2 is a diagram illustrating an exemplary embodiment of contents stored in the databases of the apparatus 3 of FIG. 1.

Referring to FIG. 2, the MK database 31 of the apparatus 3 stores medical knowledge, such as patient classification knowledge, patient similarity knowledge, etc. Such medical knowledge is provided from the MK database 11 of the health management server 1.

Referring to FIG. 2, the PHR database 32 of the apparatus 3 stores the personal health records of patients, such as information regarding a medical history, a physical character, a family history, a life style, medical data, and a demographical character of a patient. The information regarding the medical history of the patient includes, but is not limited to, whether the patient has a disorder such as diabetes, a heart disease, or hypertension. The information regarding the physical character of the patient includes, but is not limited to, an age, a sex distinction, a race, a height, and a weight of the patient. The information regarding the family history of the patient includes, but is not limited to, whether a parent or a sibling has or had a disorder such as diabetes, a heart disease, or hypertension. The information regarding the life style of the patient include information regarding whether the patient has a smoking or drinking habit. The information regarding the medical data of the patient include the patient's test results regarding glycated hemoglobin (“HbA1c”), blood pressure, and lipid, tested in a laboratory, such as a hospital. The information regarding the demographical character of the patient include information regarding the patient's race, income, educational attainment, and residential district. The personal health records of patients are provided by the MR database 12 of the health management server 1, or by the plurality of patient terminals, for example, the measuring unit 21 or the interviewing unit 22 of the patient terminal 2.

The TM database 33 of the apparatus 3 stores information telemonitored by the patient terminal 2, such as the blood-sugar level, the blood pressure level, and the weight of the patients. The telemonitored information is generally a medical signal provided from the measuring unit 21 of the patient terminal 2, but may be interview details provided from the interviewing unit 22. In one exemplary embodiment, the weight of the patient may be obtained by interviewing the patient.

The HMI database 34 of the apparatus 3 stores health management information of the patients, such as performance information regarding an exercise program, a nutrition program, a mental health program, or an education program performed by each patient. The performance information regarding an exercise program includes, but is not limited to, a type of exercise, an average exercising time, and intensity of exercise performed by a patient. The performance information regarding a nutrition program includes, but is not limited to, a type of food or medicine that a patient takes, daily calories intake of a patient, and an average mealtime of a patient. The performance information regarding a mental health program or an education program includes, but is not limited to, types of mental health program and an education program, and an amount of time that a patient has spent in each program provided by the health management server 1. Such health management information are generally interview details provided from the interviewing unit 22 of the patient terminal 2, but may be a medical signal provided from the measuring unit 21. In one exemplary embodiment, calories taken by a patient may be obtained through the measuring unit 21 of the patient terminal 2.

The data processing unit 35 of the apparatus 3 processes data about health management of the patients. Referring to FIG. 1, the data processing unit 35 includes a grouping unit 351, an order determining unit 352, an information collecting unit 353, and a report generating unit 354.

The grouping unit 351 of the data processing unit 35 classifies patients into one or more groups based on similarity of personal health records of the patients. In detail, the grouping unit 351 generates an identification (“ID”) for each of the groups based on the medical knowledge stored in the MK database 31 and the personal health records stored in the PHR database 32, and assigns each patient with an ID. The ID that a patient is assigned corresponds to the ID of the group to which the patient belongs. In other words, the grouping unit 351 classifies the patients based on the same or similar personal health records according to each patient classification item, in consideration of an order of the patient classification items regarding the degree of contribution to medical similarity of the patients.

The generating of the IDs may be performed by a unit other than the grouping unit 351 and/or the apparatus 3. In one exemplary embodiment, the health management server 1 may generate the IDs, or the MK database 31 of the apparatus 3 may receive the IDs from an external unit and store the IDs. In this case, the grouping unit 351 assigns at least one ID stored in the MK database 31 to each patient based on their personal health records stored in the PHR database 32. Specifically, for each patient, the grouping unit 351 may assign an ID of a group to which a patient belongs to the patient, by assigning the ID to a patient terminal 2 of the patient.

In one exemplary embodiment, when the personal health records of patients stored in the PHR database 32 indicate that some patients have diabetes and the remaining patients have a heart disease, and that some patients live in a city and the remaining patients live in a countryside, the patients may be classified into two groups. Since the disorders may be ranked higher than the demographical characters in the order contributing to medical similarity of the patients, the grouping unit 351 generates a group A including the patients having diabetes, and a group B including the patients having a heart disease. If the patients are classified into four groups, the grouping unit 351 generates a group A1 including the patients having diabetes and living in a city, a group A2 including patients having diabetes and living in a countryside, a group B1 including patients having a heart disease and living in a city, and a group B2 including patients having a heart disease and living in a countryside.

The order determining unit 352 of the data processing unit 35 determines an order of each patient with respect to the groups, based on health conditions of each patient stored in the TM database 33. In detail, the order determining unit 352 compares the degrees of change of the health conditions between the patients, and determines the order of each patient with respect to the groups according to a result of the comparing. Specifically, the order determining unit 352 expresses the health conditions of the patients numerically, and may compare the degrees of change by using an equation for obtaining the degrees of change as a numerical amount.

In one exemplary embodiment, for the patients having diabetes of the group A, the order determining unit 352 decides the order of the patients according to an order of decreasing degrees of blood-sugar levels. A higher order may be given, for example, to a patient within the group A whose HbA1c or fructosamine measured at home or in a hospital is decreased more. Specifically, the order determining unit 352 may compare the decreasing degrees of the blood-sugar levels between patients by considering a blood-sugar decreasing rate and a blood-sugar decreasing speed of each patient. A daily blood-sugar decreasing rate and a daily blood-sugar decreasing speed may be considered, or a weekly blood-sugar decreasing rate and a weekly blood-sugar decreasing speed may be considered.

The information collecting unit 353 of the data processing unit 35 collects health management information of each patient from the HMI database 34. In detail, the information collecting unit 353 matches health management programs performed by each patient with each patient by collecting health programs performed by each patient from the HMI database 34. An exercise program database of the HMI database 34 may store information about exercise programs performed by a plurality of patients, for example, information regarding a type of exercise, an exercise time, and intensity of exercise. The information collecting unit 353 matches performance information of an exercise program, such as the information regarding a type of exercise, an exercise time, and intensity of exercise performed by each patient with each patient by collecting the performance information of the exercise program performed by each patient.

The report generating unit 354 of the data processing unit 35 extracts health management information of a patient within an ordered group whose order determined by the order determining unit 352 is equal to or above a predetermined order from the health management information collected by the information collecting unit 353, and generates a BP report based on the extracted health management information. In detail, the report generating unit 354 generates a BP report based on a health management program performed by a patient within the ordered group whose order determined by the order determining unit 352 is equal to or above a predetermined order. In one exemplary embodiment, the report generating unit 354 generates a BP report about information regarding types of exercise, exercise times, and intensity of exercise performed by patients within the ordered group whose orders determined by the order determining unit 352 are from first to third.

The database managing unit 36 of the apparatus 3 manages the MK database 31, the PHR database 32, the TM database 33, and the HMI database 34. In one exemplary embodiment, the database managing unit 36 updates the MK database 31, the PHR database 32, the TM database 33, and the HMI database 34 by using data received from the data securing unit 37 within the apparatus 3. The MK database 31 and the PHR database 32 are generally updated as new medical knowledge and a new medical record provided from the health management server 1 are applied on the MK database 31 and the PHR database 32. The PHR database 32 may be updated as a health condition of a new patient provided from the patient terminal 2 is applied on the PHR database 32. The TM database 33 is generally updated as a health condition of a new patient provided from the patient terminal 2 is applied on the TM database 33. The HMI database 34 is generally updated as interview details of a new patient provided from the patient terminal 2 is applied on the TM database 33.

The data securing unit 37 of the apparatus 3 performs a security process on data output from or input to the communicating unit 38. In one exemplary embodiment, the data securing unit 37 may encode data output to the communicating unit 38, e.g., a BP report generated by the report generating unit 354, or may convert identification, such as a real name of a patient in the BP report into a code, such as a number or a character, that cannot be broken by an unrelated person. Alternatively, the data securing unit 37 may decode data input to the communicating unit 38, e.g., encoded data provided from the health management server 1 and/or the patient terminal 2. In an alternative exemplary embodiment, when personal medical information of a patient is prevented from being exposed, like when the health management system of FIG. 1 is installed in a closed environment, the apparatus 3 may not include the data securing unit 37.

The communicating unit 38 of the apparatus 3 may output data received from the health management server 1 and/or the patient terminal 2 through the network to the data securing unit 37, or may transmit data that is security-processed by the data securing unit 37 to the health management server 1 and/or the patient terminal 2 through the network.

In an exemplary embodiment, the BP report is transmitted to the patient terminal 2 of a patient below a predetermined order in a group that received the BP report. Also, the BP report may simultaneously be transmitted to the health management server 1. The medical professional operating the health management server 1 may determine which information is fed back to which patient or whether patients are well managed, based on the BP report, and may use the BP report for managing other patients. In detail, the communicating unit 38 of the apparatus 3 may transmit the data security processed by the data securing unit 14 of the health management server 1 periodically everyday or weekly, when an order of patients changes, or according to a request from the health management server 1 and/or the patient terminal 2.

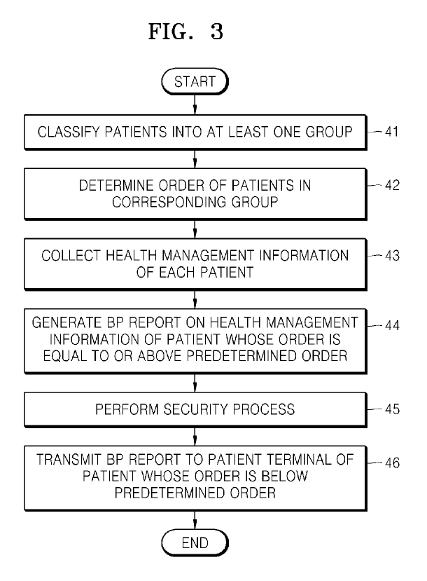

FIG. 3 is a flowchart of an exemplary embodiment of a method of providing health management information, according to the present invention. The method includes operations that are performed sequentially in the apparatus 3 of FIG. 1. Accordingly, descriptions regarding the apparatus 3 described above but omitted herein may also apply to the method.

In operation 41, the apparatus 3 classifies patients into one or more groups based on similarity of personal health records of the patients. In detail, a computer processor of the apparatus 3 classifies the patients based on the same or similar personal health records with respect to each of patient classification items, for medically classifying the patients in consideration of the order of the patient classification items, regarding the degree of contribution to medical similarity of the patients, in operation 41.

In operation 42, the apparatus 3 determines an order of each patient in a corresponding group based on health conditions of each patient stored in the TM database 33. In detail, the computer processor of the apparatus 3 compares the degrees of change of health conditions between the patients, and determines the order of the patients in the corresponding group according to a result of the comparing, in operation 42.

In operation 43, the apparatus 3 collects health management information of each patient from the HMI database 34. In detail, the computer processor of the apparatus 3 matches health management programs performed by each patient with each patient, by collecting health programs performed by each patient from the HMI database 34, in operation 43.

In operation 44, the apparatus 3 extracts health management information of a patient within an ordered group whose order determined by the order determining unit 352 is equal to or above a predetermined order from the health management information of patients collected in operation 43, and generates a BP report based on the extracted health management information. In detail, a computer processor of the report generating unit 354 generates a BP report based on a health management program performed by a patient within the ordered group whose order determined by the order determining unit 352 is equal to or above a predetermined order.

In operation 45, the apparatus 3 performs a security process on the BP report generated in operation 44. In detail, the computer processor of the apparatus 3 may encode the BP report generated in operation 44 or convert identification information, such as a real name of a patient, on the BP report into a code, such as a number or a character, that cannot be broken by an unrelated person, in operation 45.

In operation 46, the apparatus 3 transmits the BP report security-processed in operation 45 to the patient terminal 2 of at least one patient in the ordered group whose order is below the predetermined order. In detail, a computer processor of the communicating unit 38 may transmit the BP report security-processed in operation 45 periodically, such as everyday or weekly, when the order of the patients changes, or according to a request of the health management server 1 and/or the patient terminal 2.

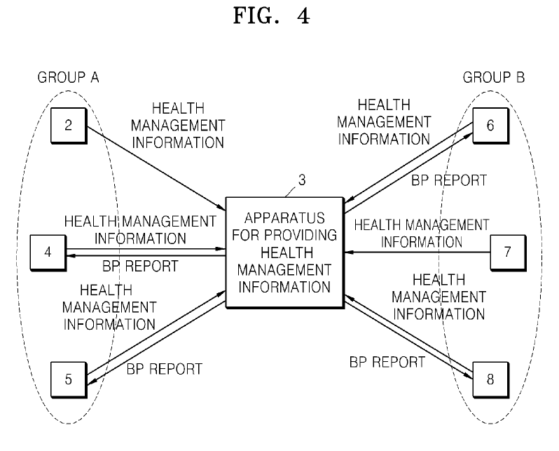

FIG. 4 is a diagram for describing an exemplary embodiment of how health management information is provided according to the health management system of FIG. 1, or the method of FIG. 3. In FIG. 4, it is assumed that the apparatus 3 classifies patients having diabetes into a group A and patients having a heart disease into a group B, and health management information of a patient ordered first in one group is provided to the remaining patient in the group.

The apparatus 3 classifies patients of patient terminals 2, 4, and 5 into the group A (e.g., diabetes), and patients of patient terminals 6, 7, and 8 into the group B (e.g., heart disease), based on similarity of personal health records of the patients. The apparatus 3 determines the patient of the patient terminal 2 as being ordered first in the group A, and the patient of the patient terminal 7 as being ordered first in group B, based on health conditions of each patient stored in the TM database 33. The apparatus 3 transmits health management information of the higher ordered patient of the patient terminal 2 to the lower ordered patient terminals 4 and 5, and health management information of the higher ordered patient of the patient terminal 7 to the lower ordered patient terminals 6 and 8.

A chronic disease, such as diabetes or a heart disease, is a disorder that cannot be cured by a temporary treatment, and a patient of the chronic disease needs to constantly take care of him/herself. Specifically, it is known that such chronic diseases are more effectively treated by motivating patients to share experiences and compete, than by one-sided management by a medical professional. Accordingly, in the illustrated embodiments of the present invention, the patients are grouped according to their personal health records, the order is determined between patients in each group, and a BP report for health management is automatically provided such as through an output device, to each patient within the ordered group, thereby motivating the patients to take care of their health. Consequently, the patients are more compliant in regards to health management, and thus the patients may manage their chronic disease by themselves. Also, the patients can correct their health management habits through the BP report, and thus each patient can improve his/her life style.

The illustrated embodiments of the present invention can be written as computer programs and can be implemented in general-use digital computers or computer processing devices, that execute the programs using a computer readable recording medium. It should be understood by one skilled in the art, that the general-use computer executes the computer programs and includes, but is not limited to, a personal computer such as a lap top or a personal digital assistant. A portion of the elements and functions of the invention may be implemented by the computer processing device, e.g., by providing an applet to the computer processing device.

Also, the structure of data used in the embodiments may be recorded on the computer readable recording medium by using various methods. The computer readable recording medium includes, but is not limited to, magnetic storage media (e.g., read-only memory (“ROM”), floppy disks, hard disks, etc.), optical recording media (e.g., compact disk read-only memory (“CD-ROMs”), or digital versatile/digital video disc (“DVDs”)), and storage media such as carrier waves (e.g., transmission through the Internet).

In one exemplary embodiment, the apparatus 3 is implemented by one computer processing system including at least a computer processor, logic and internal/external memory or storage. The computer processing system may further include any of a number of input and/or output devices. The data processing unit 35 may be the logic executing on the one computer processing system of the apparatus 3. While FIG. 1 illustrates the apparatus 3 as a single or integral group of elements and functions, it should be understood by one skilled in the art that the apparatus 3 may be implemented by a plurality of a computer processing system and/or a plurality of a computer processor.

In an alternative exemplary embodiment, the data processing unit 35 may be implemented by a first (one) computer processing system on which data processing unit 35 logic is executed, and remaining elements of the apparatus 3 may be implemented by a second (one) computer processing system on which remaining data processing logic is executed. In another alternative exemplary embodiment, the elements and functions of the grouping unit 351, the order determining unit 352, the information collecting unit 353 and/or the report generating unit 354 within the data processing unit 35 may be implemented by individual computer processing systems.

As should be understood to one skilled in the art, in exemplary embodiments of the invention, the elements and functions of the health management server (system) 1 and the patient terminal (system) 2 may be implemented by one or more computer processing systems and computer processors. For illustrative purposes, with reference to the exemplary embodiment in FIG. 1, the health management server system 1, the patient terminal system 2 and the apparatus 3 are shown as separate systems or units, however, the invention is not limited thereto. Where the generating of the IDs may be performed by a unit other than the grouping unit 351 and/or the apparatus 3, for example, where the health management server 1 generates the IDs or the MK database 31 of the apparatus 3 receives the IDs from an external unit, a single computer processing system may implement a group of elements and functions of the health management server system 1, the patient terminal system 2 and the apparatus 3 described herein.

For illustrative purposes, with reference to the exemplary embodiment in FIG. 1, connection to the network is shown directly to the communication units 15, 24 and 38. However, one skilled in the art should understand that the network may be connected to any one of the elements or functions of the health management server system 1, the patient terminal system 2 and the apparatus 3, respectively.

Similarly, one skilled in the art should understand that the invention is not limited to the MK database 31, the PHR database 32, the TM database 33, the HMI database 34, and the data securing unit 37 respectively connected directly to the grouping unit 351, the order determining unit 352, the information collecting unit 353 and the report generating unit 354. Alternatively, the MK database 31, the PHR database 32, the TM database 33, the HMI database 34, and the data securing unit 37 may be connected to any one of the elements or function of the data processing unit 35.

In an exemplary embodiment, databases may be implemented using a variety of devices for storing electronic information. It is understood that the databases may be implemented using memory contained in a computer processing system or that it may be a separate physical device. Information stored in the databases may be retrieved and manipulated via the computer processing system of the invention. Access control with respect to the data stored in the databases may be managed via an authentication mechanism (e.g., firewall) configured by the computer processing system to create and manage the invention described herein.

Results of, and interim processing details of any of the units of the health management server 1, the patient terminal 2 and the apparatus 3 may be outputted to a user, e.g., the medical professional or the patient. The outputting of the results or processing details may be performed by displaying such results and processing details on a user interface, such as a display panel, a graphical user interface, a computer processor monitor, etc. The interviewing unit 22 that displays a BP report or a question related to a health condition of the patient using the patient terminal 2, for example, or the health management server 1 displaying the decoded health management information from the data securing unit 14 described above, may employ a graphical user interface to display the respective information. Methods of displaying information may include, but are not limited to, textual, graphical and auditory formats.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A method of providing health management information, the method comprising:
classifying patients into one or more groups based on similarity between personal heath records of the patients;
determining an order between patients in a group, based on corresponding health conditions of the patients, for each group; and
providing health management information of at least one patient in an ordered group whose determined order is equal to or above a predetermined order, to at least one patient in the ordered group whose determined order is below the predetermined order.

2. The method of claim 1, wherein, in the providing health management information, the health management information is provided by transmitting a report based on a health management program performed by the patient whose determined order is equal to or above the predetermined order, to a terminal of the patient whose determined order is below the predetermined order.

3. The method of claim 1, wherein, in the determining an order between patients in a group, the order of each patient with respect to the groups to which the patients belong is determined based on health conditions indicated by corresponding medical signals of each patient within the groups to which the patients belong.

4. The method of claim 3, wherein, in the determining an order between patients in a group, the order of each patient with respect to the groups to which the patients belong is determined according to a result of comparing the degrees of change of the health conditions between the patients within the groups to which the patients belong.

5. The method of claim 1, wherein, in the classifying patients into one or more groups, the patients are classified based on the same or similar personal health records with respect to each of patient classification items for medically classifying the patients.

6. The method of claim 5, wherein, in the classifying patients into one or more groups, the patients are classified in consideration of an order of the patient classification items with regards to the degree of contribution to medical similarity of the patients.

7. The method of claim 1, wherein the providing health management information comprises:
collecting health management information of each patient; and
extracting health management information of the patient whose determined order is equal to or above the predetermined order from the collected health management information, and providing the extracted health management information to the patient whose determined order is below the predetermined order.

8. The method of claim 1, further comprising performing a security process on the health management information of the patient whose determined order is equal to or above the predetermined order,
wherein, in the providing health management information, the security processed health management information is provided.

9. A computer readable recording medium having recorded thereon a program for executing a method of providing health management information, the method comprising:
classifying patients into one or more groups based on similarity between personal heath records of the patients;
determining an order between patients in a group, based on corresponding health conditions of the patients, for each group; and
providing health management information of at least one patient in an ordered group whose determined order is equal to or above a predetermined order to at least one patient in the ordered group whose determined order is below the predetermined order.

10. An apparatus for providing health management information, the apparatus comprising:
a computer processing system; and
a data processing unit executing on the computer processing system, the data processing unit implementing:
classifying patients into one or more groups based on similarity between personal heath records of the patients;
determining an order of each patient with respect to groups to which the patients belong, based on corresponding health conditions of the patients;
generating a report based on health management information of at least one patient within an ordered group whose determined order is equal to or above a predetermined order; and
transmitting the generated report to at least one patient in the ordered group whose determined order is below the predetermined order.

11. The apparatus of claim 10, wherein the data processing unit generates a report based on a health management program performed by the patient whose determined order is equal to or above the predetermined order.

12. The apparatus of claim 10, wherein the data processing unit determines the order of each patient with respect to the groups to which the patients belong, based on health conditions indicated by corresponding medical signals of each patient.

13. The apparatus of claim 12, wherein the data processing unit determines the order of each patient with respect to the groups to which the patients belong according to a result of comparing the degrees of change of the health conditions between the patients.

14. The apparatus of claim 10, wherein the data processing unit classifies the patients based on the same or similar personal health records with respect to each of patient classification items for medically classifying the patients.

15. The apparatus of claim 14, wherein the data processing unit classifies the patients in consideration of an order of the patient classification items with regards to the degree of contribution to medical similarity of the patients.

16. The apparatus of claim 10, wherein the computer processing system implements collecting health management information of each patient,
wherein the data processing unit extracts health management information of the patient whose determined order is equal to or above the predetermined order from the collected health management information, and generates a report based on the extracted health management information.

17. The apparatus of claim 10, wherein the computer processing system implements performing a security process on the report,
wherein the data processing unit transmits the security processed report.

18. The apparatus of claim 10, wherein the data processing unit transmits the report to and receives data from a health management system.

19. The apparatus of claim 10, wherein the data processing unit transmits data to and receives data from a patient terminal system.
